(19) United States
(12) Patent Application Publication
(10) Pub. No.: US 2018/0053199 A1
(43) Pub. Date: Feb. 22, 2018

(54) AUTO-SEGMENTATION

(71) Applicant: ADOBE SYSTEMS INCORPORATED, San Jose, CA (US)

(72) Inventors: Craig MATHIS, American Fork, UT (US); Trevor PAULSEN, Lehi, UT (US)

(21) Appl. No.: 15/243,118

(22) Filed: Aug. 22, 2016

(51) Int. Cl. G06Q 30/02; G06F 17/30

(52) U.S. Cl. CPC G06Q 30/0204; G06F 17/30598

(57) ABSTRACT

Systems and methods are disclosed herein for automatically identifying segments of customers based on customers having similar characteristics and behaviors. In one embodiment of the invention, event-level records representing customer interactions for multiple customers are received and the event-level records are summarized to combine attributes for respective customers into customer-level records. The customer-level records include attributes for customer characteristics and behaviors based on summarizing the event-level records. Systems and methods further cluster the customer-level records based on the attributes for customer characteristics and behaviors and, based on the clustering, identify segments of clusters having a statistically significant value relative to other clusters. The systems and methods display the identified segments on a user-interface.

### TECHNICAL FIELD

This disclosure relates generally to computer-implemented methods and systems and more particularly relates to improving the efficiency and effectiveness of computing systems used to identify customer segments and identify statistically significant differences that distinguish customer segments.

### BACKGROUND

Businesses often attempt to categorize their customers into segments. For example, customers are exposed to a given business in different ways, buy different types of products, gravitate towards different content, and react to promotions differently. As a customer interacts with the business, whether on-line, at brick and mortar locations, or in response to advertising, the customer often assumes a profile or behaviors that are similar to other customers. The process of identifying these groups of customers and their similar behaviors is called “segmentation.” A “segment” or variations of the term herein, is a set of customers or customer data defined by one or more identified characteristics. Segmentation generally involves a marketer manually identifying characteristics of customers for a group based on the marketer's expectation that the customers with those characteristics will behave similarly to one another. For example, a marketer may identify a group of customers that have a particular customer loyalty status as one segment and a group of customers who have visited a particular website at least 3 times as another segment.

Electronic systems used to help marketers define segments, track segments, and market to segments of customers face numerous difficulties. Marketers are generally required to manually define segments. As a result, segments are often defined arbitrarily based on intuition and gut feelings. More specifically, marketers must define a segment based on their assumptions of the attributes collected for each of their customers. For example, a marketer may define a segment as customers who followed a link from a Facebook® webpage and then had more than 3 page views, but have no way of knowing if customers in that segment actually have common attributes reflecting how the customer's actually behave.

The complexity and format of the multiple datasets of information about customer attributes reflecting how the customers actually behave makes identifying meaningful segments difficult. Such datasets of consumer data generally include hundreds of possible dimensions (pagename, region, campaign, referrer, etc.) and metrics (page view, visits, purchases, etc.) making it nearly impossible to know how these should be combined into key groups that a marketer wants to focus on. Most marketers are not aware of the possible fields being collected or how the metrics and fields relate. Marketers may also be unaware of new or smaller groups that play a significant role in their business. In addition, datasets of the attributes reflecting how the customers actually behave generally include event/hit level data that does not summarize customer-level information or otherwise provide information in a manner that would be useful for identifying meaningful segments.

### SUMMARY

Systems and methods are disclosed herein for automatically identifying segments of customers based on customers having distinguishing characteristics and/or behaviors. The systems and methods receive event-level records containing attributes of customer interactions for multiple customers and summarize the event-level records for respective customers into customer-level records. The customer-level records include attributes for customer characteristics and behaviors based on summarizing the event-level records. The systems and methods cluster the customer-level records based on the attributes for customer characteristics and behaviors and, based on the clustering, segments of customers having similar statistically differing attributes for customer characteristics and behaviors are identified.

Another embodiment of the invention allows the systems and methods to cluster customer-level records based on the attributes for customer characteristics and behaviors. Based on the clustering, the segments of customers having similar attributes for customer characteristics and behaviors are identified and statistically significant distinguishing segments of attributes for customer characteristics and behaviors segments are determined. The segment-specific information is presented on a user-interface, where the segment specific information represents selected statistically significant distinguishing segments of attributes for customer characteristics and behaviors.

In other embodiments, certain attributes of customer characteristics and behaviors are excluded from the customer-level records. For example, excluding certain attributes that do not vary in a statistically significant way or attributes that are unpopulated in a statistically significant number of records may improve processing time without affecting the quality of the segment data produced.

These illustrative features are mentioned not to limit or define the disclosure, but to provide examples to aid understanding thereof. Additional embodiments are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings.

FIG. 1 illustrates an example of a computer environment suitable to automatically identify segments of customers based on customers having similar characteristics and behaviors.

FIG. 2 illustrates an example of another embodiment of a computing environment suitable to automatically identify segments of customers based on customers having similar characteristics and behaviors.

FIG. 3 illustrates an example of event-level records of customers' interaction with a system.

FIG. 4 illustrates an example of event-level records summarized into customer-level records.

FIG. 5 illustrates an example of clustered customer-level records.

FIG. 6 illustrates an example of a user-interface to select a range of segments of interest and the number for the systems and methods to generate.

FIG. 7 illustrates an example of a user-interface of a system providing segmentation results.

FIG. 8 illustrates another example of a user-interface of a system providing segmentation results.

FIG. 9 is a flow chart illustrating an exemplary method for automatically identifying segments of customers.

FIG. 10 is a flow chart illustrating an exemplary method for automatically identifying segments of customers.

FIG. 11 is a block diagram depicting an example hardware implementation.

### DETAILED DESCRIPTION

As described above, existing systems require marketers to manually select segment and do not have customer-level data available to facilitate defining segments. Embodiments of the invention address these and other issues, by a computing system summarizing customer event-level records to combine events for respective customers into customer-level data and automatically identifying significant groups of customers for segments based on common behaviors of customers that are identified using the customer-level data. The techniques use clustering of customer-level data based on similar behaviors to automatically identify significant groups for segments without the marketers having to make assumptions about customer behavior or otherwise define the segments themselves. Various techniques may be used to facilitate the automatic clustering of customers for segmentation. For example, a feature selection technique is used in one embodiment to reduce the complexity of the customer information that is used in the clustering to significantly improve the efficiency of the process.

Some embodiments of the invention facilitate use of the automatically-identified segments by presenting them in a user-interface that allows the marketer to easily understand which attributes reflecting the behaviors of the customers in a segment best distinguish customer in the segments from other segments. Thus the user-interface presents meaningful segments that the marketer may want to use to segment his or her customers and provides information about how the behaviors of customers in those potential segments differ from customers not in the respective segments. Thus a marketer can select a segment from the potential segment that best distinguishes particular behaviors of the customer. As a specific example, the marketer can identify a potential segment in which interaction responding to e-mail marketing distinguish the customers in the segment from those not in the segment and then send targeted e-mails to customers in that segment.

As another specific example, the marketer may be presented with particular segments that would not have otherwise occurred to her given the vast number of different attributes tracked. Such unexpected segments may yield insights into customer and/or customer behavior. Based on this revelation, the marketer may take appropriate action, for example, sending a targeted advertisement, coupon, communication or the like only to a relatively small number of customer types that have a high conversion percentage, or those who have sufficient interactions along a path to conversion to lead to a high likelihood that a conversion is imminent.

As used herein the phrase “analyst” or “marketer” refers to a person or entity that identifies segments or groups of customers, sends online ads or otherwise creates and/or implements and/or assesses the effectiveness of a marketing campaign to market to customers.

As used herein the phrase “attribute” refers to an item of tracked customer data. For example, attributes include customer data such as dimensions and metrics.

As used herein the phrase “behaviors” refers to at least one, preferably more than one, set of attributes associated with a customer's activities or actions. For example, a customer may have interacted with an online ad, visited a site and placed an item in a wish list.

As used herein the phrase “characteristics” refers to at least one, preferably more than one, set of attributes associated with a customer or a customer's devices. For example, a customer may have an attribute of using the browser “Chrome,” using an “iPhone,” and having a geographical identifier of “Ohio.”

As used herein, the phrase “customer” refers to any person who uses or who may someday use an electronic device such as a computer, tablet, cell phone, or any other electronic device that collects user interactions such as “internet of things” devices such as refrigerators, watches, TV's, etc. to execute a web browser, use a search engine, use a social media application, or otherwise use the electronic device to access electronic content for example through an electronic network such as the Internet. Accordingly, the phrase “customer” includes any person that data is collected about via electronic devices, in-store interactions, and any other electronic and real world sources. Some, but not necessarily all, customers access and interact with electronic content received through electronic networks such as the Internet. Some, but not necessarily all, customers access and interact with online ads received through electronic networks such as the Internet. Marketers send some customers online ads to advertise products and services using electronic networks such as the Internet. In other embodiments, marketers send materials via mail, text message, and other methods of communicating. Customers include potential purchasers and thus a potential purchaser need not have made a purchase to be considered a customer.

As used herein, the phrase “customer-level records” refers to event-level records that have been sorted or summarized into a single record for a single customer. For example, a customer may have one event-level record indicating a search query for “down jackets;” a second event-level record indicating a purchase of a pair of gloves. A single customer level record would include the attributes of both these event-level activities, and indeed all of the event-level attributes associated with the customer.

As used herein, the phrase “dimension” refers to non-numerically-ordered information about one or more customers or segments, including, but not limited to page name, page uniform resource locator (URL), site section, product name, and so on. Dimensions are generally not ordered and can have any number of unique values. Dimensions will often have matching values for different customers. For example, a state dimensions will have the value “California” for many customers. In some instances, dimensions have multiple values for each customer. For example, a URL dimension identifies multiple URLs for each customer in a segment.

As used herein, the phrase “electronic content” refers to any content in an electronic communication such as a web page or e-mail or test message accessed by, or made available to, one or more individuals through a computer network such as the Internet or a text messaging network. Examples of electronic content include, but are not limited to, images, text, graphics, sound, and/or video incorporated into a message, web page, search engine result, or social media content on a social media app or web page.

As used herein, the phrase “event-level records” refers to records recording customer interactions with a business. The records may include any trackable data such as various attributes collected during a customer interaction with a business. For example, raw event-level records may include attributes such as customer ID, browser, advertising campaign, conversion, referral source, visit number, and the like where the number of columns of tracked items is an ever growing list of dimensions and metrics being collected.

As used herein, the phrase “metric” refers to numeric information about one or more customers or segment including, but not limited to, age, income, telephone number, number of televisions, people, sessions, click-through rate, view-through rate, number of videos watched, conversion rate, revenue, revenue per thousand impressions (“RPM”), where revenue refers to any metric of interest that is trackable, e.g., measured in dollars, clicks, number of accounts opened and so on. Generally, metrics provide an order, e.g., one revenue value is greater than another revenue value which is greater than a third revenue value and so on.

As used herein, the phrase “online ad” or “promotion” or “advertising” or “coupon” refers to an item that promotes an idea, product, or service that is provided, accessed by, or made available to one or more customers. Examples include, but are not limited to, images, text, graphics, sound, and/or video incorporated into a web page, search engine result, social media content on a social media app or web page, mailed, texted, or otherwise delivered to an customer or set of customers that advertise, discount or otherwise promote or sell something, usually a business's product or service.

As used herein, the phrase “segment” refers to a set of customer data defined by one or more identified attributes. For example, all customers who have made at least two online purchases is a segment and all customers who are platinum reward club members is another segment. Within a given population of customers, segments can entirely or partially overlap with one another. In the above example, some customers who have made at least two online purchases are also platinum reward club members, and thus those segments partially overlap with one another.

As used herein, the phrase “statistically significant value” refers to a value that is statistically distinguishable from other values. As a particular example, algorithms such as the K-Means algorithm, expectation-maximization (EM), and forms of hierarchical clustering suitably identify statistically significant values based on the data set being analyzed.

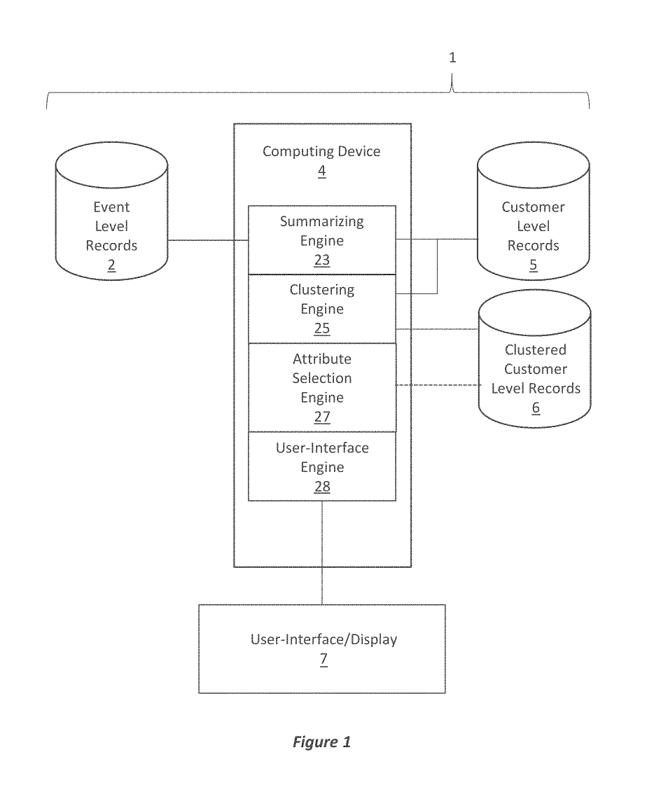

FIG. 1 illustrates an exemplary computer environment in which an exemplary system for automatically identifying segments of customers based on customers having similar characteristics and behaviors is shown. The exemplary computer environment 1 includes a data store of event-level records 2, a computing device 4 in communication with a data store of customer-level records 5 and a data store of clustered customer-level records 6, as well as a user-interface/display 7. The computing device 4 may include several engines to complete specific tasks. It is appreciated that the engines may be implemented in hardware, software or combinations and that the engines, although illustrated separately, may be combined in whole or in part or may be further subdivided. As more completely discussed below, computing device 4 may include a summarizing engine 23, a clustering engine 25, an attribute selecting engine 27 and a user-interface engine 28.

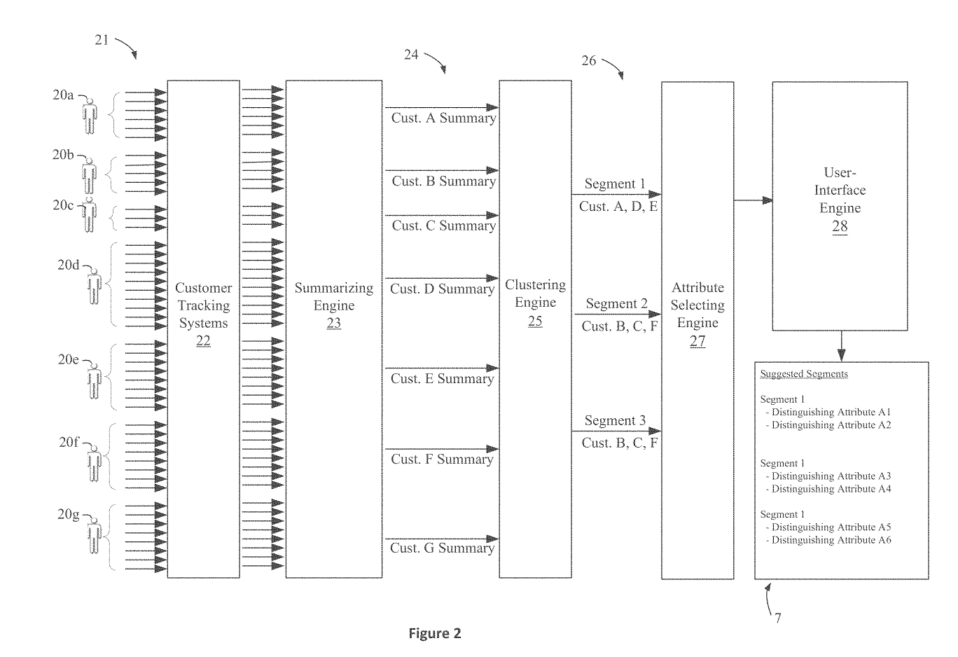

FIG. 2 depicts a system suitable to implement aspects of the disclosure. A number or unique visitors or customers 20a-20g have various interactions 21 with a particular business that each may be tracked, event by event, by customer tracking systems 22 and stored in one or more event-level record data stores 2 (FIG. 1). Summarizing engine 23 takes the various interactions 21 and combines or summarizes them into customer-level records 24. Clustering engine 25 assesses the customer-level records and groups various customers with statistically significant attributes into segments 26. An attribute selection engine 27 reviews the segments 26 and selects a number (analyst selectable or calculated) of segments with distinguishing attributes for display. User-interface engine 28 manipulates and displays the selected segments on the user-interface 7.

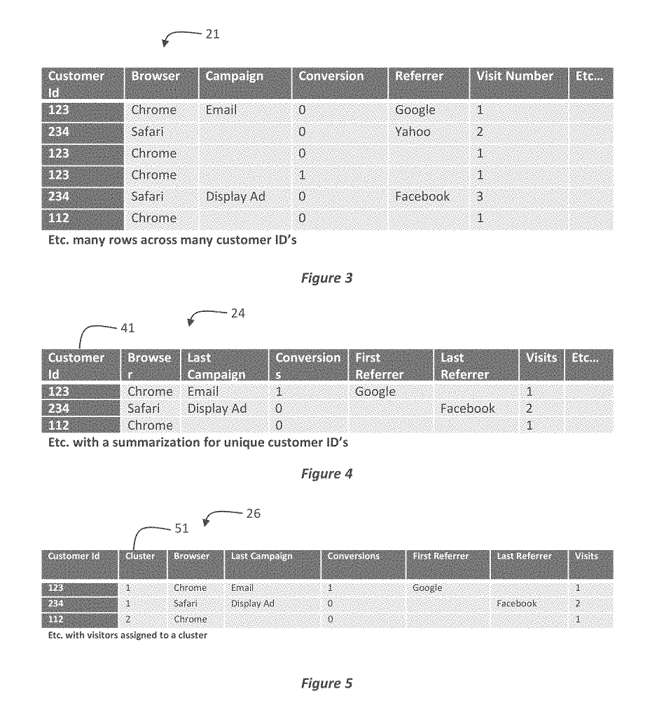

FIG. 3 illustrates an example of event-level records 21. An analyst or marketer (not shown) may, for example, initiate a query involving certain event-level records 21. Summarizing engine 23 will access or receive event-level records 21 containing attributes of customer interaction events for multiple customers 20a-20g. For example, raw event-level data may be collected and stored by an analytics or customer tracking system 22. Samples of this hit level or event-level data can include attributes such as “customer ID,” “browser,” “advertising campaign,” “conversion,” “referral source,” “visit number,” and the like where the number of columns is an ever growing list of dimensions and metrics being collected.

Referring back to FIGS. 1 and 2, summarizing engine 23 may summarize various event-level records 21 into records 24 that correspond to specific customers 20a-20g. Visitor records may be summarized by combining all the events for a given customer and aggregating them into a single record. For example, the system and method may create a field representing the last visit date, last purchase date, last purchase amount, first visit date, total revenue, average time per visit, etc. The final record for each visitor could easily consist of hundreds of fields depending on the data available. These are termed “customer-level records” 24 and these may be stored in a customer-level record memory or database 5. An example of customer-level records is depicted in FIG. 4 where various event-level records are depicted as summarized by unique customer ID's 41 providing an overview of customer attributes.

Referring back to FIGS. 1 and 2, clustering engine 25 may access the customer-level records 24 and cluster a number of customers with similar attributes into common clusters 26 of customer-level records. Clustering engine 25 determines the optimal group count based on a desired percentage of customers in each cluster recognizing that, for marketing purposes, many analysts or marketers are not interested in clusters/groups with only two or three customers. An example of clustered customer-level records 26 is depicted in FIG. 5 where the cluster is represented in a “cluster” column 51.

In one embodiment, to reduce the amount of time needed to group the visitors, the system and method may reduce the number of input columns or attributes to consider. This process is termed “feature selection” and allows the system and method to reduce the input size by removing sparsely populated columns or those that have little variance. One approach known as Principal Component Analysis (PCA) mathematically combines the columns into a new set of input features that will often reduce the input space into only a few features needed to capture the majority of the variance within the data. The clustering engine 25 may then cluster the customer-level records against this new smaller input space.

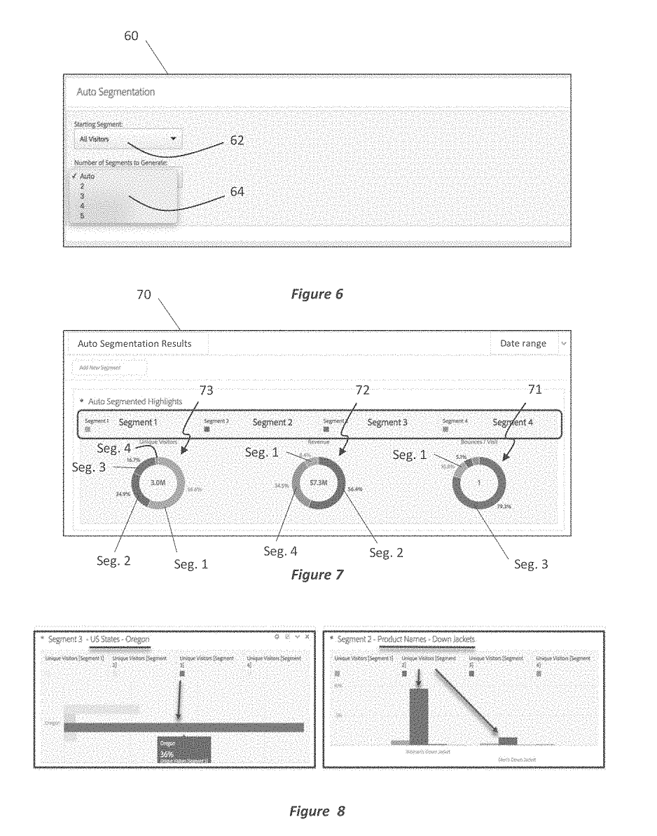

In another embodiment, clustering may take an approach known as expectation-maximization (EM), but other options may include forms of hierarchical clustering, or the popular K-Means algorithm. Through a user-interface as seen, for example, in FIG. 6, the marketer may provide the system and method with the segments to consider 62 and a number of groups/segments they would like to be identified 64, or allow the system and method to automatically determine the optimal group count based on a desired percentage of customers in each cluster (again, generally the system and method is not interested in clusters/groups with only two or three customers).

Referring back to FIGS. 1 and 2, with customers now classified into an assigned cluster, the attribute selecting engine 27 may access the clustered customer-level records 26 and determine key attribute differences. An attribute selection process then automatically compares each group/cluster across all available attributes to select segments or groups having a significantly higher or lower value per visitor. The selected segments are then passed to a user-interface engine 28 for display on the user-interface/display 7.

For example, as best depicted in FIG. 7, if one cluster/group on average has a higher bounce per visit, then that metric, “Bounces/Visit” 71, will be shown in the user-interface 7 as an attribute that is significantly different in one of the groups, for example, Seg. 3 showing 79.3% of visitors identified with that attribute. Similarly, with other attributes (browser, campaign, referrer, etc.) the system and method will automatically search through all available attribute values (browser types, each keyword, each referrer, etc.) and identify any value that is used more frequently in one group over the others. For example, other attributes depicted in FIG. 7 include “Revenue” 72 and “Unique Visitors” 73.

With continued reference to FIG. 7, without having any prior awareness of the segments automatically identified, an analyst or marketer may conclude that visitors in Seg. 4, while comprising less than 2% of unique visitors 73 but contributing 36.5% of revenue 72 are suitable candidates for additional promotions, advertising or the like. Similarly, the analyst or marketer may conclude visitors in Seg. 3 as being mere window shoppers having an outsize bounce/visit 71 rate and making no contribution to revenue 72.

With reference now to FIG. 8, the analyst or marketer may interact with the user-interface to more closely review selected attributes and segments. For example, Seg. 3 is shown as a geographical attribute indicating visitors coming from the US state of Oregon, 81. The user-interface illustrates that of the unique visitors shown, 36% of those lie in Seg. 3 so further analysis may be needed to identify the cause of the disproportionate interest in that group from that state. As another example, Seg. 2 identifies a product level attribute of “Down Jackets,” perhaps indicating a successful advertising campaign.

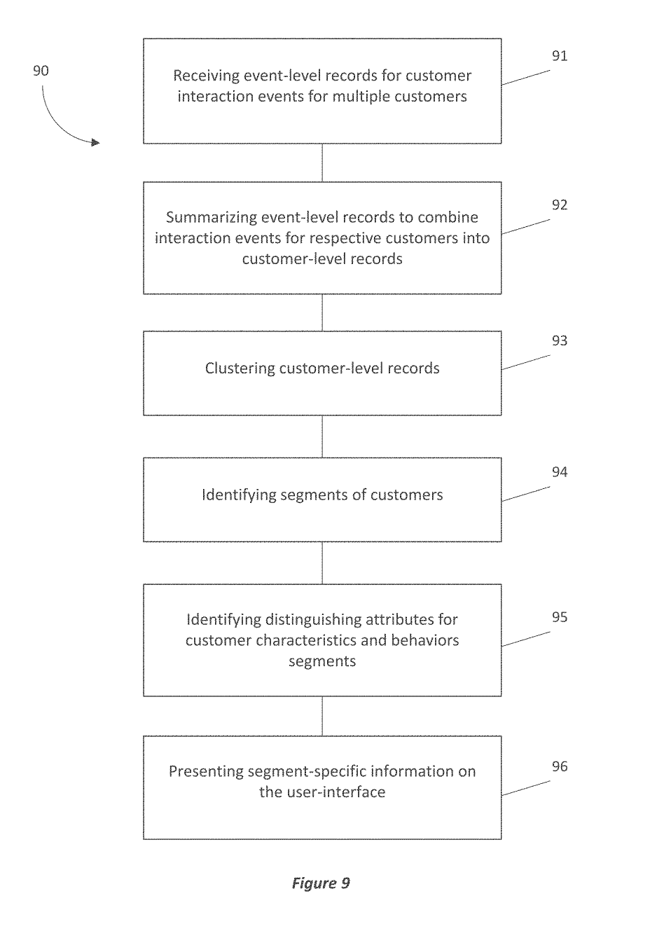

FIG. 9 is a flow chart illustrating an exemplary method 90 for identifying segments of customers based on similar attributes. Exemplary method 90 is performed by one or more processors of one or more computing devices such as computing device 4 of FIG. 1. Method 90 includes receiving event-level records containing attributes for multiple customers, as shown in block 91. The event-level records comprise a series of individual interactions by an identifiable customer with a business including interactions occurring on a web-page or pages. In one example, this hit level or event-level data can include attributes such as “customer ID,” “browser,” “advertising campaign,” “conversion,” “referral source,” “visit number,” and the like where the number of entries is an ever growing list of attributes being collected.

The method 90 further includes summarizing the event-level into interaction events by specific respective customers creating customer-level records, as shown in block 92. The customer-level records may include various interactions occurring over one customer visit or many visits involving various levels of interaction with the business. For example, the customer-level records may include an identifying information, location, browser, initial visit, referral source and date/time as well as a subsequent visit or visits with respective date/time data and levels of interaction including, searching for an item, placing an item in a wish list, placing an item in a shopping cart, removing an item from a shopping cart, and/or purchasing an item.

Embodiments of the invention, including but not limited to the method 90, of FIG. 9, provide techniques to reduce the amount of time needed to group the visitors, the method may reduce the number of interactions or attributes to consider. This process is termed “feature selection” and allows the method to reduce the input size by removing sparsely populated columns or those that have little variance. One approach known as Principal Component Analysis (PCA) mathematically combines the columns into a new set of input features that will often reduce the input space into only a few features needed to capture the majority of the variance within the customer-level data.

The method 90 further includes clustering the customer-level records, as shown in block 93. The customer-level records may be clustered based on the attributes for customer characteristics and behaviors. In one embodiment, clustering may take an approach known as expectation-maximization (EM), but other options may include forms of hierarchical clustering, or the K-Means algorithm. In another embodiment, an analyst may provide the method with the segments to consider and/or a number of groups/segments to be identified, or the analyst may indicate that the method automatically determine the optimal group count based on a desired percentage of customers in each cluster.

The method 90 further includes identifying segments of the clustered customer-level records, as shown in block 94. For example, the segments may include those with customers having similar attributes. The method 90 may analyze the identified segments for those with distinguishing attributes from other segments/attributes as shown in block 95. The method 90 may further include presenting identified segment specific information on the user-interface, as shown in block 96.

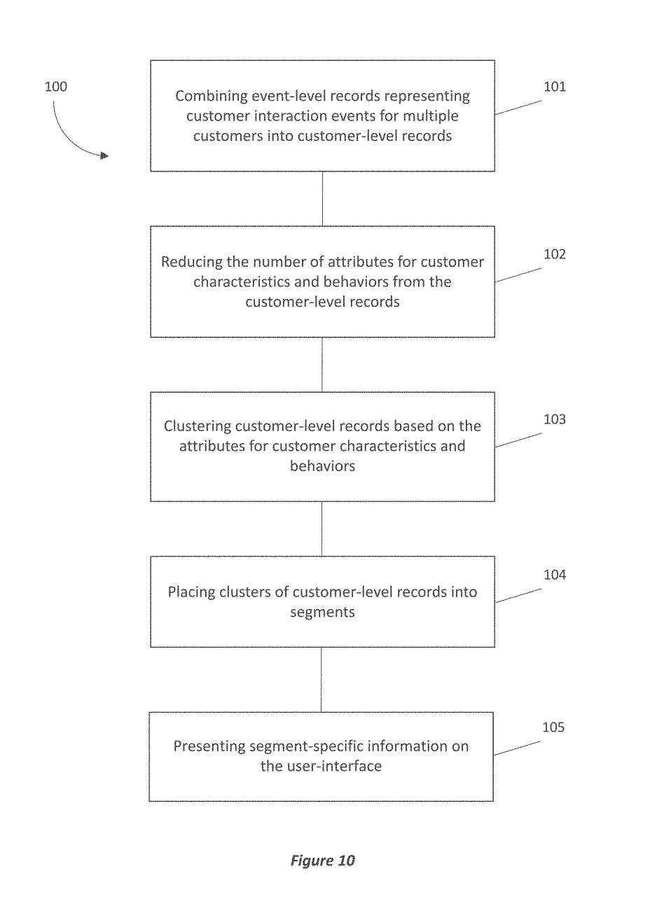

FIG. 10 is a flow chart illustrating an exemplary method 100 for identifying segments of customers based on similar attributes. Exemplary method 100 may be performed by one or more processors of one or more computing devices such as computing device 4 of FIG. 1. Method 100 includes combining event-level records containing attributes for multiple customers into customer-level records, as shown in block 101. The customer-level records include attributes for customer characteristics and behaviors.

Method 100 further includes reducing the number of attributes for customer characteristics and behaviors from the customer-level records, as shown in block 102. For example, the method may reduce the input size by removing sparsely populated columns or those that have little variance. In one embodiment the attributes are reduced into a new set of input features that may reduce the input space into only a few features needed to capture the majority of the variance within the customer-level data.

Method 100 further includes clustering customer-level records based on the attributes for customer characteristics and behaviors, as shown in block 103. For example, the method may cluster together or commonly identify clusters of customers having similar attributes.

Method 100 further includes placing clusters of customer-level records into segments, as shown in block 104. For example, the segments may identify a statistically significant deviation of an attribute within the customer characteristics and behaviors.

Method 100 further includes presenting segment-specific information on the user-interface, as shown in block 105.

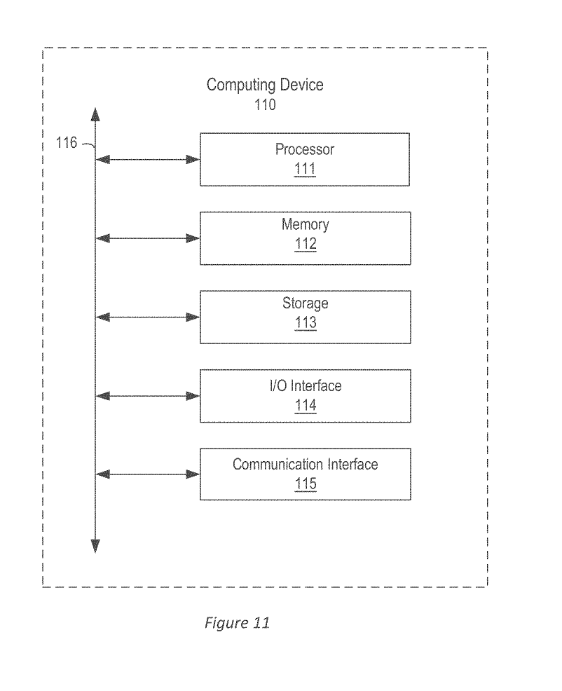

Any suitable computing system or group of computing systems can be used to implement the techniques and methods disclosed herein. For example, FIG. 11 is a block diagram depicting examples of implementations of such components. A computing device 110 can include a processor 111 that is communicatively coupled to a memory 112 and that executes computer-executable program code and/or accesses information stored in memory 112 or storage 113. The processor 111 may comprise a microprocessor, an application-specific integrated circuit (“ASIC”), a state machine, or other processing device. The processor 111 can include one processing device or more than one processing device. Such a processor can include or may be in communication with a computer-readable medium storing instructions that, when executed by the processor 111, cause the processor to perform the operations described herein.

The memory 112 and storage 113 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 110 may also comprise a number of external or internal devices such as input or output devices. For example, the computing device is shown with an input/output (“I/O”) interface 114 that can receive input from input devices or provide output to output devices. A communication interface 115 may also be included in the computing device 110 and can include any device or group of devices suitable for establishing a wired or wireless data connection to one or more data networks. Non-limiting examples of the communication interface 115 include an Ethernet network adapter, a modem, and/or the like. The computing device 110 can transmit messages as electronic or optical signals via the communication interface 115. A bus 116 can also be included to communicatively couple one or more components of the computing device 110.

The computing device 110 can execute program code that configures the processor 111 to perform one or more of the operations described above. The program code can include one or more modules. The program code may be resident in the memory 112, storage 113, or any suitable computer-readable medium and may be executed by the processor 111 or any other suitable processor. In some embodiments, modules can be resident in the memory 112. In additional or alternative embodiments, one or more modules can be resident in a memory that is accessible via a data network, such as a memory accessible to a cloud service.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure the claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. In an environment in which customer interactions are tracked, a method for automatically identifying segments of customers based on customers having similar characteristics and behaviors, the method comprising:
a computing device receiving event-level records containing attributes of customer interactions for multiple customers;
the computing device summarizing the event-level records to combine interaction events for respective customers into customer-level records, the customer-level records including attributes for customer characteristics and behaviors based on summarizing the event-level records;
the computing device clustering customer-level records based on the attributes for customer characteristics and behaviors; and
based on the clustering, the computing device identifying segments of clusters having a statistically significant value relative to other clusters.

2. The method as set forth in claim 1 further comprising reducing the number of attributes for customer characteristics and behaviors from the customer-level records that the clustering considers by statistically assessing distributions of the attributes for customer characteristics and behaviors.

3. The method as set forth in claim 1, wherein the attributes for customer characteristics and behaviors include behavioral metrics.

4. The method as set forth in claim 3, wherein the behavior metrics include a page view metric, a visits metric, a purchases metric, a last visit date, a last purchase date, a last purchase amount metric, a first visit date, a total revenue metric, or an average time per visit metric.

5. The method as set forth in claim 1, wherein the attributes for customer characteristics and behaviors include dimensions.

6. The method as set forth in claim 5, wherein the dimensions identify a browser, keyword, or page name used by the respective customers.

7. The method as set forth in claim 5, wherein the dimensions identify a geography, location, marketing campaign, or referrer associated with the respective customers.

8. The method as set forth in claim 1, wherein the clustering includes at least one of expectation-maximization, hierarchical clustering, and a K-Means algorithmic clustering.

9. The method as set forth in claim 1 further comprising representing results of the segmenting step on a user-interface.

10. The method as set forth in claim 1 further comprising:
identifying the most distinguishing attributes for customer characteristics and behaviors segments of the segments; and
presenting segment-specific information on a user-interface, the segment specific information identifying the most distinguishing attributes for customer characteristics and behaviors segments of the segments.

11. The method as set forth in claim 1, wherein the attributes for customer characteristics and behaviors further comprise a sequence of attributes occurring over time where the identifying segments of clusters step identifies a cluster based on the sequence of attributes regardless of the time over which the attributes occurred.

12. In an environment in which customer interactions with a business are tracked, a method for automatically segmenting customers having similar characteristics and behaviors, the method comprising:
a computing device combining event-level records representing customer interactions for multiple customers into customer-level records, the customer-level records including attributes for customer characteristics and behaviors;
the computing device clustering customer-level records based on the attributes for customer characteristics and behaviors;
based on the clustering, the computing device identifying segments with statistically significant distinguishing segments of attributes for customer characteristics and behaviors relative to other segments; and
presenting segment-specific information on a user-interface, the segment specific information representing selected statistically significant distinguishing segments of attributes for customer characteristics and behaviors.

13. The method as set forth in claim 12, wherein the attributes for customer characteristics and behaviors further comprise a sequence of attributes occurring over time where the identifying segments step identifies a cluster based on the sequence of attributes regardless of the time over which the attributes were recorded.

14. The method as set forth in claim 12 further comprising feature selecting out certain attributes having statistically insignificant variability.

15. The method as set forth in claim 12 further comprising feature selecting out certain attributes having statistically insignificant amounts of data.

16. The method as set forth in claim 12, wherein the attributes for customer characteristics and behaviors include behavioral metrics.

17. The method as set forth in claim 12, wherein the attributes for customer characteristics and behaviors include dimensions.

18. A system for automatically segmenting customers having significantly differing characteristics and behaviors from a database of tracked event-level records, the system comprising:
a computing device including a processor for executing computer readable instructions; and
a non-transient storage device in communication with the processor, where the storage device contains non-transient instructions which, upon execution, cause the processor to:
summarize event-level records to combine attributes for respective customers into customer-level records, where the customer-level records include attributes for customer characteristics and behaviors based on summarizing the event-level records;
cluster the customer-level records based on the attributes for customer characteristics and behaviors; and
based on the clustering, identify a segment of clusters having a statistically significant value for certain attributes of customer characteristics and behaviors relative to other clusters.

19. The system as set forth in claim 18, wherein the non-transient instructions, upon execution, cause the processor to display the segment of clusters having a statistically significant value for certain attributes of customer characteristics and behaviors relative to other clusters on a user-interface.

20. The system as set forth in claim 18, wherein the non-transient instructions, upon execution, cause the processor further to reduce the number of attributes for customer characteristics and behaviors from the customer-level records by statistically assessing distributions of the attributes for customer characteristics and behaviors.
